(19) United States
(12) Patent Application Publication
(10) Pub. No.: US 2010/0026654 A1
(43) Pub. Date: Feb. 4, 2010

(54) COORDINATE INPUT DEVICE

(75) Inventor: John G. Suddreth, Cave Creek, AZ (US)

Correspondence Address: HONEYWELL/IFL;Patent Services, 101 Columbia Road, P.O.Box 2245, Morristown, NJ, 07962-2245, US

(73) Assignee: Honeywell International Inc., Morristown, NJ (US)

(21) Appl. No.: 12/181,808

(22) Filed: Jul. 29, 2008

(51) Int. Cl. G06F 3/044; G06F 3/045

(52) U.S. Cl. 345/174; 345/173

(57) ABSTRACT

A force and movement sensitive non-mechanical coordinate input device (100, 200) provides tactile feedback to a finger (110) of the finger's position on the coordinate input device (100, 200). The coordinate input device (100, 200) includes a plurality of sensing layers (104) having a recognizable shape (112, 212). The sensing layers (104) include at least first and second layers (302, 306) that sense movement of a finger (110), at least a third layer (204) for sensing a force applied by the finger (110), wherein the recognizable shape (112, 212) provides tactile feedback to the finger (110) of the position of the finger (110) on the coordinate input device (100, 200).

### FIELD OF THE INVENTION

The present invention generally relates to user interfaces for electronic devices and more particularly to a non-mechanical coordinate input device.

### BACKGROUND OF THE INVENTION

The market for electronic devices having user interfaces, for example, televisions, computer monitors, cell phones, personal digital assistants (PDA's), digital cameras, and music playback devices (MP3), is very competitive. Manufactures are constantly improving their product with each model in an attempt to cut costs and production requirements.

In many electronic devices, coordinate input devices, for example a trackball, provide intuitive input from the user to a computer or other data processing devices. The coordinate input devices are especially useful in portable communication devices where other input devices typically occupy much more area.

There are many different types of coordinate input devices, including capacitive, resistive, infrared, and surface acoustic wave. All of these technologies sense the position of touches on the device. The device generally includes a surface area across which a finger is moved to a desired position to identify a coordinate, for example, an item for selection. However, these known devices typically do not provide feedback to the user of the location of the finger on the surface.

It has been previously been disclosed in U.S. Pat. No. 6,492,979 to use a combination of capacitive touch screen and force sensors to prevent false touch. This disclosure however complicates the sensor interface and can not sense multiple touch forces at the same time. It has also been proposed in U.S. Pat. No. 7,196,694 to use force sensors at the peripherals of the touch screen to determine the position of a touch. This disclosure however does not offer a capability of multi-touch. And neither of these two patents provides feedback to the user of the position of a finger on the device. It has been proposed in U.S. Pat. No. 7,321,361 to use a coordinate input device having a convex shape for providing such feedback to the user; however, the application of a force is sensed with a mechanical switch.

Accordingly, it is desirable to provide a force and movement sensitive non-mechanical coordinate input device that provides tactile feedback to a finger of the finger's position on the coordinate input device. Furthermore, other desirable features and characteristics of the present invention will become apparent from the subsequent detailed description and the appended claims, taken in conjunction with the accompanying drawings and this background.

### BRIEF SUMMARY OF THE INVENTION

A force and movement sensitive non-mechanical coordinate input device provides tactile feedback to a finger of the finger's position on the coordinate input device. The device includes a plurality of sensing layers having a recognizable shape. The sensing layers include at least first and second layers that sense movement of an operating member, at least a third layer for sensing a force applied by the operating member, wherein the recognizable shape provides tactile feedback to the operating member of the position of the operating member on the coordinate input device.

### BRIEF DESCRIPTION OF THE DRAWINGS

The present invention will hereinafter be described in conjunction with the following drawing figures, wherein like numerals denote like elements, and

FIG. 1 is a cross section of a coordinate input device in accordance with one exemplary embodiment;

FIG. 2 is a cross section of a coordinate input device in accordance with another exemplary embodiment;

FIG. 3 is a perspective view of capacitive sensing layers as may be used with the exemplary embodiment;

FIG. 4 is a block diagram of a device incorporating the exemplary embodiments; and

FIG. 5 is a cross section of a coordinate input device in accordance with yet another exemplary embodiment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A force and movement sensitive non-mechanical coordinate input device provides tactile feedback to a finger of the finger's position on the coordinate input device. The coordinate input device is formed of a plurality of force and movement sensing layers in a concave or convex shape giving a user the tactile feel of an operating member's, e.g., a finger, location on the device. As the operating member moves across the coordinate input device, the movement and amount of pressure is sensed, for example, by a matrix of conductors in the sensing layers. The coordinate input device is free of moving parts resulting in cost and reliability advantages over mechanical track ball devices. Optionally, one of the sensing layers, preferably the one adjacent the operating member, may comprise a texture that varies in proportion to the amount of pressure, resulting in a variable degree of ease in which the operating member moves across the surface and providing feedback to the operating member.

This coordinate input device may be used in many types of electronic devices, including a mobile device such as a cell phone and a personal digital assistant (PDA), a computer, a mouse for a computer, and the like.

There are many different types of touch sensing technologies, including capacitive, resistive, infrared, and surface acoustic wave. All of these technologies sense the position of touches on a screen. However, it is desirable to have a touch sensing device that not only senses the position of the touch, but also the force applied to the touch screen. Force sensing provides an extra dimension of freedom in inputting: it can simplify the input process by enabling different combinations of positions and forces on a touch screen. It also offers the possibility of discriminating against false touches by setting different force thresholds before a touch can register. An additional advantage is that force sensing is not limited to only finger touch as in the case of capacitive sensing, it also accept input from almost all other devices including stylus, glove, and credit cards. It is also more tolerant to environmental noises such as EMI and dirt/oil on surface.

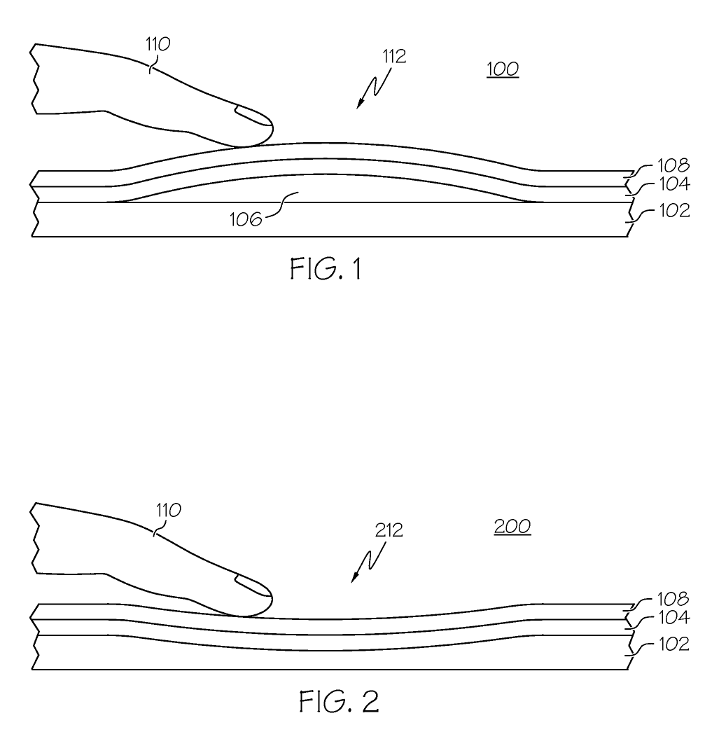

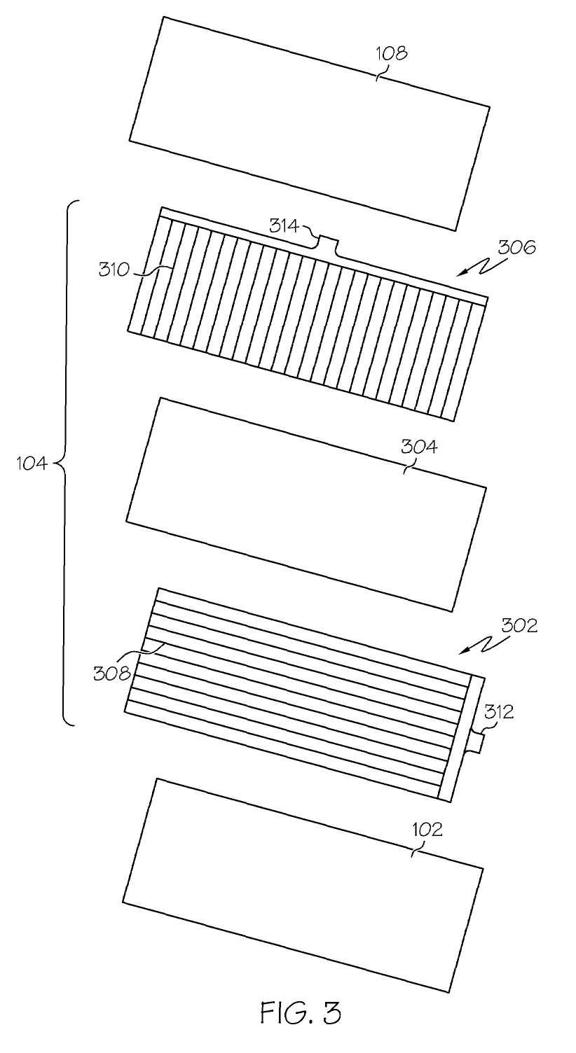

Referring to FIG. 1, an exemplary embodiment of the coordinate input device 100 includes a plurality of movement and force sensing layers 104 formed over a substrate 102. A material 106 is formed between the substrate 102 and sensing layers 104 giving the sensing layers 104 a convex shape 112. Alternatively, a channel (see FIG. 2) may be formed in the substrate 102 instead of forming the material 106 to give the sensing layers 104 a concave shape 212. A protective layer 108 may be formed over the sensing layers 104 to protect the sensing layers 104 from scratching, dirt, and oil. The substrate 102, material 106, and protective layer 108 may be any rigid material, but is preferably glass, a polymer, or a metal. When an operating member 110, such as a finger, is moved across the coordinate input device 100, the movement and pressure is sensed by the sensing layers 104. The operating member 110 will be able to sense its approximate position on the coordinate input device 100 due to the convex or concave shape 112, 212 of the device 100, 200. As the operating member 110 is moved across the surface of the coordinate input device 100, 200, it will sense whether it is moving up an incline or down an decline, or between the incline and decline, thereby providing an impression of the location of the operating member 110 on the surface.

The sensing layers 104 may sense changes in, for example, capacitance, resistance, infrared, or surface acoustic wave characteristics. The exemplary embodiment shown in FIG. 3 senses changes in capacitance wherein the sensing layers 104 include conductive layers 302 and 306 separated by a dielectric layer 304. The conductive layers 302 and 306 each comprise a patterned plurality of adjacent but separated conductive traces 312 and 314, respectively. The conductive traces 308 are generally orthogonal to the conductive traces 310, providing a matrix of pixels, or a plurality of intersections, for sensing a capacitance therebetween. As the operating member 110 moves across the coordinating input device 100, 200, the capacitance at each of the intersections of the traces 308, 310 experience a change in capacitance. The traces 308, 310 are preferably aligned in respective directions and have a pitch of 0.05-10 mm, (preferably 1.0 mm), a width less than the pitch but larger than 0.001 mm, a thickness of 1.0-1000 nm, (preferably 80 nm). The traces 308, 310 may be a conductive oxide, for example, indium tin oxide, zinc oxide, and tin oxide. A tab 312, 314 is electrically coupled to each trace for providing connection to other circuitry as is known in the industry.

Though various lithography processes, e.g., photolithography, electron beam lithography, imprint lithography, ink jet printing, may be used to fabricate the coordinate input device 100, 200 and especially the patterned conductive traces 308, 310, a printing process is preferred. A variety of printing techniques, for example, Flexo, Gravure, Screen, and inkjet, may be used.

The sensing layers 104 also sense the pressure in a manner such as shown in U.S. Pat. Nos. 6,492,979 and 7,196,694, or in the document “Paper FSRs and Latex/Fabric Traction Sensors: Methods for the Development of Home-Made Touch Sensors”, by Rodolphe Koehly et al., Proceedings of the 2006 International Conference on New Interfaces for Musical Expression (NIME06), Paris, France, which are hereby incorporated by reference. For example, a conductive ink such as carbon black pigment may be mixed into a medium such as polyvinyl acetate, varnish, or liquid black inks.

By being able to sense this change in resistance due to pressure being applied to the transparent pressure sensor 300, the selection of modes, or functions, may be accomplished.

By scanning the rows and columns of the conductive traces and mapping the capacitance of the materials at each intersection, a corresponding map of the coordinate input device may be obtained. This map provides both the position and the force of the corresponding touch. The placing of multiple fingers on the screen can be distinguished, thus enabling greater freedom of inputting. The amount of force of the touch may be used, for example, as a variable gain on the input. A light touch may indicate a high gain on the position output, while a hard touch would indicate a lower gain on the position output. Additionally, the amount of force could be used as a z-axis position or as a zooming control.

In a further embodiment, a thin layer comprising a texture, for example, a semi-flexible layer containing electro-rheological or magneto-rheological fluid, that varies in proportion to the amount of pressure results in a variable degree of ease in which the operating member moves across the surface. This fluid changes in viscosity proportional to electric or magnetic field. So as more pressure is applied, the gain changes, and a corresponding electro or magnetic field is applied to the fluid and the viscosity increases, making it harder to move across the surface. This increase or decrease in texture and ease of finger movement is sensed by the finger's touch. This textured layer preferably comprises the protective layer 108; however, may comprise a textured layer 109 shown in FIG. 5.

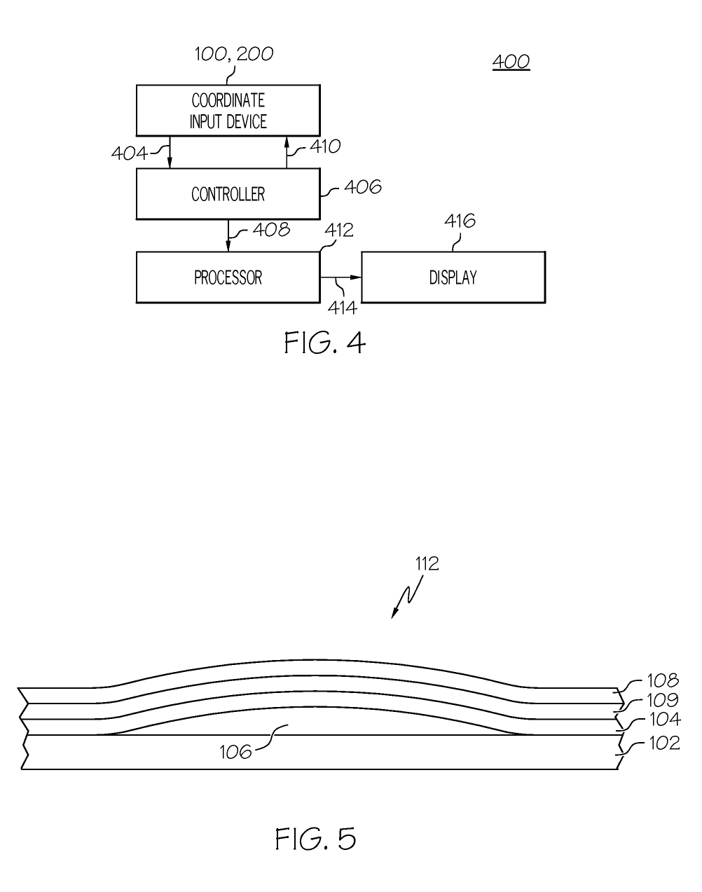

While the coordinate input device described herein may be used in electronic devices in general, a block diagram of a display system 400 as an example using the coordinate input device 100 is depicted in FIG. 4. A touch screen controller 406 provides drive signals 410 to the coordinate input device 100, and a sense signal 404 is provided from the coordinate input device 100 to the controller 406, which periodically provides a signal 408 of the distribution of pressure to a processor 412. The processor interprets the controller signal 408, determines a function in response thereto, and provides a signal 414 to a display 416. Although the display 416 is shown in this exemplary embodiment, other types of devices or systems, such as a mapping system, may receive the signal 414.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A coordinate input device comprising:
a substrate; and
a plurality of sensing layers formed over the substrate, the sensing layers having a recognizable shape and comprising:
at least first and second layers that sense movement of an operating member; and
at least a third layer for sensing a force applied by the operating member, wherein the recognizable shape provides tactile feedback to the operating member of the position of the operating member on the coordinate input device.

2. The coordinate input device of claim 1 wherein the plurality of sensing layers comprise a convex shape.

3. The coordinate input device of claim 1 wherein the plurality of sensing layers comprise a concave shape.

4. The coordinate input device of claim 1 wherein the at least first and second layers comprise a capacitive sensor.

5. The coordinate input device of claim 1 wherein the at least a third layer comprise means for sensing a force.

6. The coordinate input device of claim 1 wherein the plurality of sensing layers further comprises a fourth layer disposed on a side of the coordinate input device opposed to the substrate and that changes in texture in response to pressure from the operating member.

7. The coordinate input device of claim 1 wherein the plurality of sensing layers further comprises a fourth layer disposed on a side of the coordinate input device opposed to the substrate and that changes in texture in response to pressure from the operating member, and a fifth layer disposed over the fourth layer, the fifth layer comprising a material resistant to scratching and abrasions.

8. A coordinate input device comprising:
at least first and second layers that determine movement of an operating member by sensing a first electrical characteristic; and
at least a third layer that determines a force applied by the operating member by sensing a second electrical characteristic, the at least first and second layers, and the at least third layer comprises a shape that provides tactile feedback to the operating member of the position of the operating member on the coordinate input device; and
a controller coupled to the coordinate input device that senses a change in the first electrical characteristic when the operating member is moved on the coordinate input device and that senses a change in the second electrical characteristic when a force is applied to the coordinate input device by the operating member.

9. The coordinate input device of claim 8 wherein the at least first and second layers provides a varying capacitance as the first electrical characteristic.

10. The coordinate input device of claim 8 wherein the at least third layer provides a varying resistance as the second electrical characteristic.

11. The coordinate input device of claim 8 wherein the at least first and second layers comprises first and second patterned layers separated by a dielectric layer.

12. The coordinate input device of claim 8 wherein the at least first and second layers comprise first and second layers of a conductor material on opposed surfaces of the transparent matrix, at least one of the first and second layers being patterned, the first and second layers being coupled to the controller for selectively measuring the resistance at one of a plurality of pixels.

13. The coordinate input device of claim 8 wherein the at least first and second layers and the at least a third layer comprise a convex shape.

14. The coordinate input device of claim 8 wherein the at least first and second layers and the at least a third layer comprise a concave shape.

15. The coordinate input device of claim 8 wherein the plurality of sensing layers further comprises a fourth layer disposed on a side of the coordinate input device opposed to the substrate and that changes in texture in response to pressure from the operating member.

16. A coordinate input device comprising:
a substrate;
at least first and second layers formed over the substrate that determine movement of an operating member by sensing a first electrical characteristic; and
at least a third layer that determines a force applied by the operating member by sensing a second electrical characteristic, the at least first and second layers, and the at least third layers comprise a convex shape that provides tactile feedback to the operating member of the position of the operating member on the coordinate input device;
a controller coupled to the coordinate input device that senses a change in the first electrical characteristic when the operating member is moved on the coordinate input device and that senses a change in the second electrical characteristic when a force is applied to the coordinate input device by the operating member; and
a device receiving an output from the controller and providing information in response to the movement and force applied by the operating member.

17. The coordinate input device of claim 16 wherein the plurality of sensing layers comprise a convex shape.

18. The coordinate input device of claim 16 wherein the plurality of sensing layers comprise a concave shape.

19. The coordinate input device of claim 16 further comprising a fourth layer disposed over the at least a third layer and that changes in texture in response to pressure from the operating member.

20. The coordinate input device of claim 16 further comprising a fourth layer disposed over the at least a third layer and that changes in texture in response to pressure from the operating member, and a fifth layer disposed over the fourth layer, the fifth layer comprising a material resistant to scratching and abrasions.
